(19) United States
(12) Patent Application Publication
(10) Pub. No.: US 2012/0109699 A1
(43) Pub. Date: May 3, 2012

(54) BUSINESS RISK SYSTEM AND PROGRAM

(76) Inventor: David M. Hatfield, Midland, MI (US)

(21) Appl. No.: 13/284,587

(22) Filed: Oct. 28, 2011

Related U.S. Application Data
(60) Provisional application No. 61/407,484, filed on Oct. 28, 2010.

(51) Int. Cl. G06Q 10/06

(52) U.S. Cl. 705/7.12; 705/7.28

(57) ABSTRACT

A system and program captured in a computing device for managing the risk of a new business opportunity. The system and computing device accept data and creates plans to optimally reduce the risk of new business opportunities and then uses the resulting data to create management reports that can be both viewed or integrated into existing management reporting systems. A training module can be integrated with the system. The entire system can be operated via the cloud so as to allow users to interface the system remotely.

### CROSS-REFERENCE TO RELATED APPLICATIONS

This application is a non-provisional application which claims the benefit of Provisional Application Ser. No. 61/407,484 filed Oct. 28, 2010, which is incorporated by reference herein in its entirety.

### FIELD OF THE INVENTION

The present invention relates generally to a system and program for managing the development of new businesses and products within platforms and project portfolios, and in particular, a scalable system that manages the risk of potential new business opportunities that utilizes a computing device that is configured to allow a user to input financial and risk profile data for each new business opportunity, utilize a hypothesis driven algorithm to create the optimal plan for de-risking each new business opportunity, and then capturing information and providing output components so that a user and their organization can be fully informed about business choices. A training module can be integrated with the system. The entire system can be operated via the cloud so as to allow users to interface the system remotely.

### BACKGROUND AND SUMMARY OF THE INVENTION

Many companies, businesses within those companies, and research and development organizations today put greater emphasis on growth through innovation. Their goals often go beyond product line extensions, geographic expansion, and the traditional “bolt-on” acquisitions typical of mature businesses. Companies often know that long-term success will be dependent on re-focusing the power of their existing capabilities to create sustainable, high value breakthrough business growth. This, however, in the past has not been efficiently accomplished because the lack of scalable tools are available to help evaluate and remove the risks that are associated with potential business opportunities.

It has been said that there is an approximate 90% failure rate for new product line introductions. The cause for such high failure rate can be attributed to many factors. Nonetheless, there is an ever increasingly greater need for the development of new businesses and technologies so as to grow the global economy. Thus, there is a need in the present business environment to overcome the inefficient, low yield for effort, and high level failure rate that currently exists in the development of new products and businesses. Further, even though many companies have high level talent and a great level of sophistication for their corporate capabilities, few companies have successfully harnessed their latent power with a unique system that is specifically designed to reduce the risk of breakthrough business opportunities.

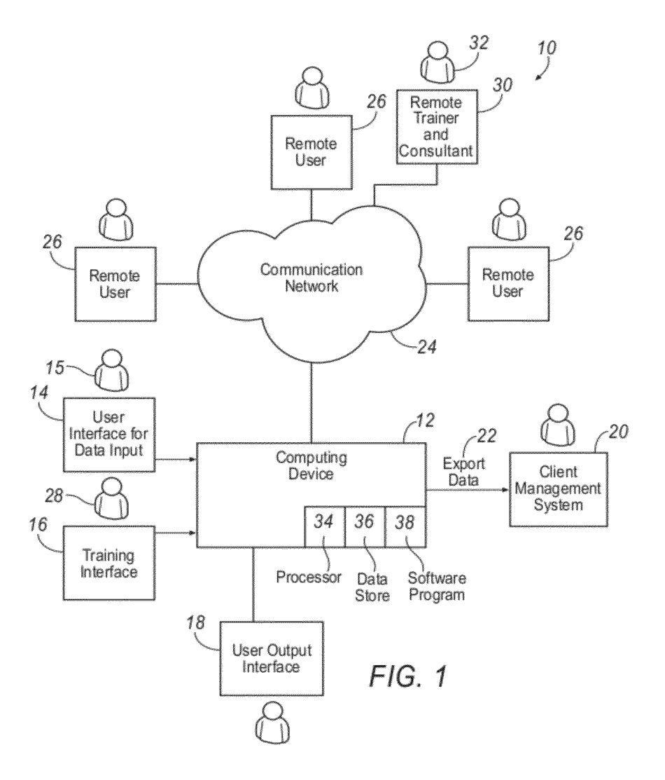

Traditionally the tools employed by corporations for new product development are what are known as stage-gate systems. Current systems are not effective when it comes to managing the risk that accompanies breakthrough new business opportunities. Such traditional processes are based on past product developments with predetermined uncertainties resolved in a predetermined linear order. For example, see FIG. 1, where a traditional linear stage-gate process is depicted. It traditionally begins with a discovery that leads to a plurality of stage-gates where each stage has its own specific uncertainties within the stage. However, breakthrough new business opportunities not only involve uncertainty, but also ambiguity. With ambiguity, it is not clear around which variables to solve uncertainty or in what order they should be resolved, if at all.

Traditional linear stage-gate processes can cause project teams in management that are involved in the development of new business opportunities to become frustrated. They intuitively know the linear process is directing them to resolve the wrong uncertainty at the wrong time. Such uncertainty can lead to the rejection of a risk reduction process of any kind, fully exposing the organization to the risk inherent to breakthrough opportunities and eliminating the possibility that success rates can be improved.

Further problems arise when the faulty risk assessments generated in traditional linear stage-gate processes are aggregated into higher level management systems. Often large organizations will consider multiple new business opportunities at once which yield large volumes of data that are spread across several systems. Without an effective discipline and system for evaluating individual opportunities, the resulting lack of order makes it difficult on a large scale to clearly understand the true opportunities and down side to a set of opportunities that may be under consideration within an organization. Thus, the traditional process of assessing new business opportunities lacks a high level of order, a discipline regarding risk, and is surrounded by uncertainty and ambiguity. It would be beneficial to help corporate deal flow by improving this system.

It would be desirable to provide an improved method and program to reduce the risk of new business development by adding a high level of order and discipline that effectively minimizes uncertainty and ambiguities that are associated with new business opportunities. It would also be desirable to provide a computing system that is in communication with at least one human interface input device that provides for the input of information about each new business opportunity. The computing device through a hypothesis driven algorithm creates an optimal plan for de-risking each such new business opportunity and then provides an output for the user in the form of graph, text, and tables so as to allow the user to gain knowledge about the proposed opportunity. The system is operable to communicate via a network so as to allow remote users to engage the system and provide their input. It would also be desirable for the system to be capable of distributing training medium about managing risk and using the system. Users and trainers can also communicate with the system remotely and engage in training sessions and monitor input in order to more effectively use the system.

One aspect of the present invention provides a consistent analysis between projects and enables teams to work remotely and collaborate with one another about the potential for a new business opportunity without having to be at one particular site. Another aspect of the present invention is that it can be used as a stand alone new business process tool, or it can be easily integrated into existing systems for managing new business development by virtue of its linking capabilities to pre-existing corporate management business systems.

Another aspect of the present invention is that it utilizes twelve hypothesis stated variables that holistically capture risk for a given new business opportunity, identifies what level of certainty exists for each of these hypotheses, as well as providing a user interface for inputting the financial impact for each hypothesis. A computing device processes these hypotheses and generates a spider diagram displaying a visual level of certainty for each of these twelve hypotheses. A proprietary hypothesis driven algorithm based on the financial analysis of each hypothesis correlates a value and a level of certainty in order to identify the most critical issues that need to be resolved at a particular point of the project. The company may react based upon these critical issues in order to resolve certain of them so as to reduce risk. Once certainty is increased for these critical issues, the system optimally reduces the associated risk. As such, the hypotheses are then restated based upon the new learning and the reduced risk and uncertainty and the impact on the value of each hypothesis are re-evaluated. The hypothesis driven algorithm is then reapplied, critical issues reprioritized, and a new set of actions can be taken by the management team in order to reduce risk. A benefit of the present system is that this process is implemented iteratively by identifying the most critical issues after each step and then focusing directed learning that optimally reduces risk.

According to another aspect of the present invention, a system and program for assessing new business risk opportunities includes identifying a hypothesis of opportunity, its validity and financial impact for business opportunities, receiving data associated with the hypothesis of opportunity, its associated validity and financial impact, receiving a priority of critical issues, and then creating by a computing device de-risking plans and actions. According to another aspect of the present invention, a tangible computer readable medium embodying computer-executable instructions for automating hypothesis directed learning, has instructions comprising, receiving, at a data entry screen, hypotheses of opportunity variables, then calculating a financial characterization of costs, and other key variables, and then outputting to a display output screen, data and results to hierarchically identify risk of the potential new business opportunity.

### DETAILED DESCRIPTION OF THE FIGS.

The present invention is illustrated by way of example and is not limited to the figures in which similar references indicate similar elements.

FIG. 1 is a schematic representation of a business risk system employing a computing device depicting the present invention, showing multiple users interfacing the system;

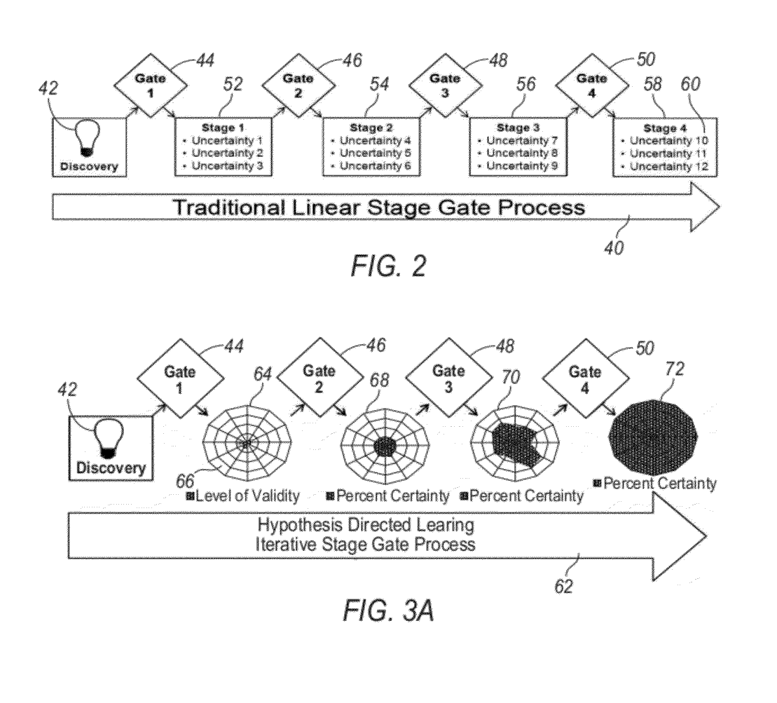

FIG. 2 is a schematic representation of a traditional linear stage-gate process for assessing business risk;

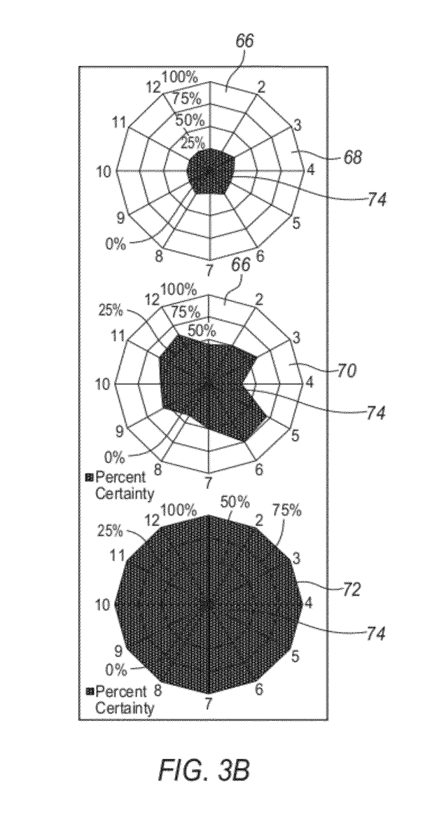

FIG. 3A is a schematic representation of the present invention, showing the novel iterative stage-gate process depicting spider diagrams for presenting business risk certainty;

FIG. 3B are the spider diagrams as shown in FIG. 3A, showing the levels of certainty for each hypothesis of opportunity variable;

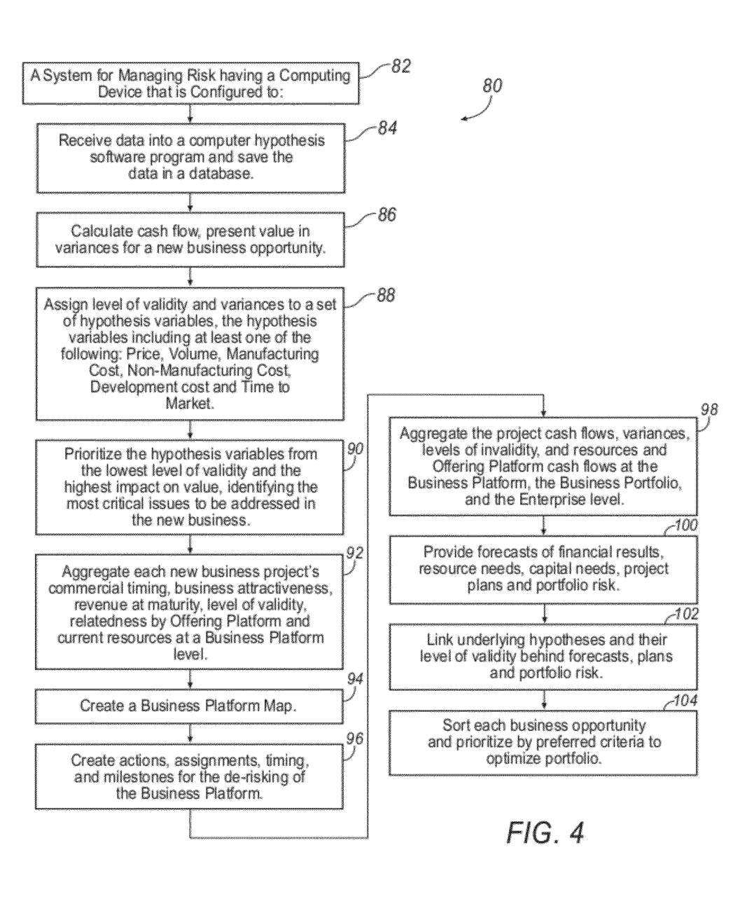

FIG. 4 is a schematic representation of a system for managing new business development, illustrating a computer device that is configured to perform certain tasks;

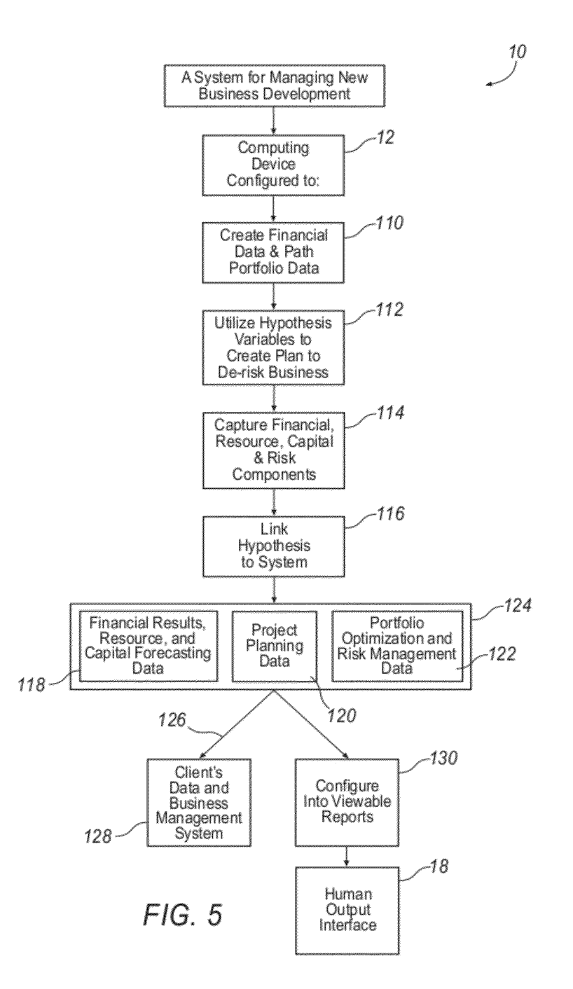

FIG. 5 is a schematic representation of a system for managing new business development, illustrating a computing device and its configurations;

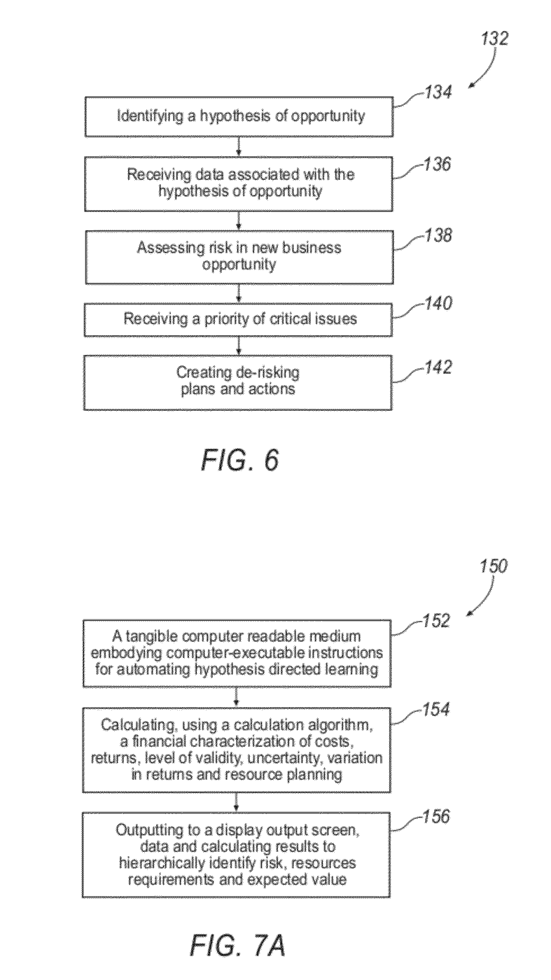

FIG. 6 is a top level schematic representation of a system for assessing risk and new business opportunities, illustrating the steps a computing device employs;

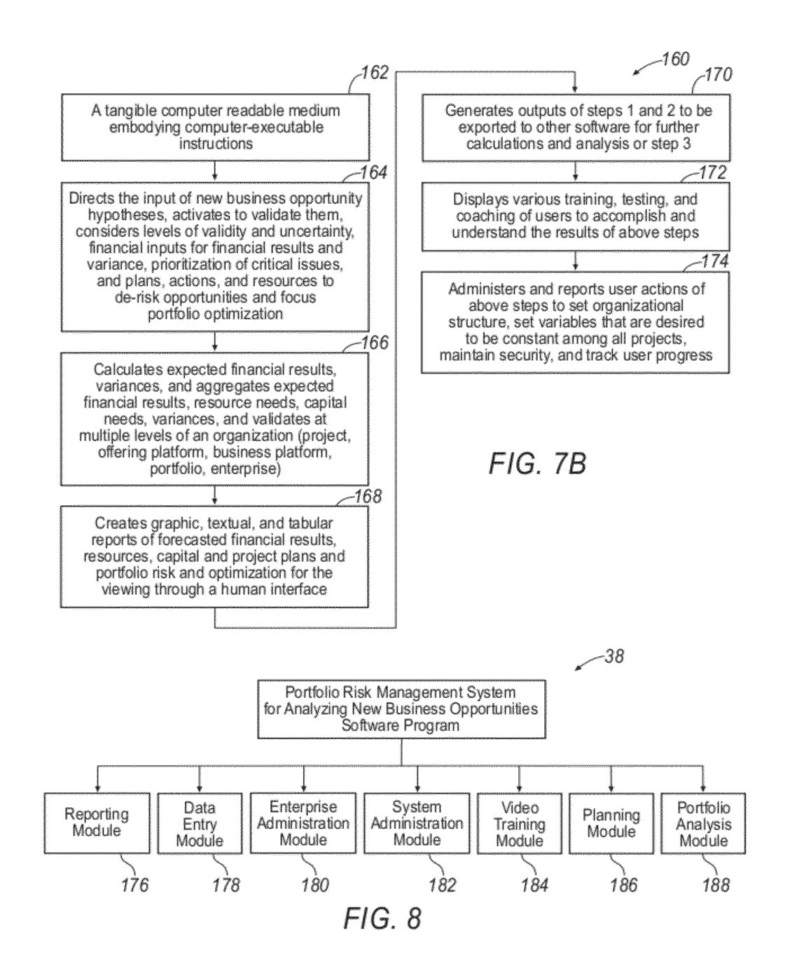

FIG. 7A is a schematic representation of a business risk assessment system employing a tangible computer readable medium;

FIG. 7B is a schematic representation of an alternative business risk assessment system employing a tangible computer readable medium;

FIG. 8 is a schematic representation of the various modules a user interfaces with when operating the portfolio risk management computer software program;

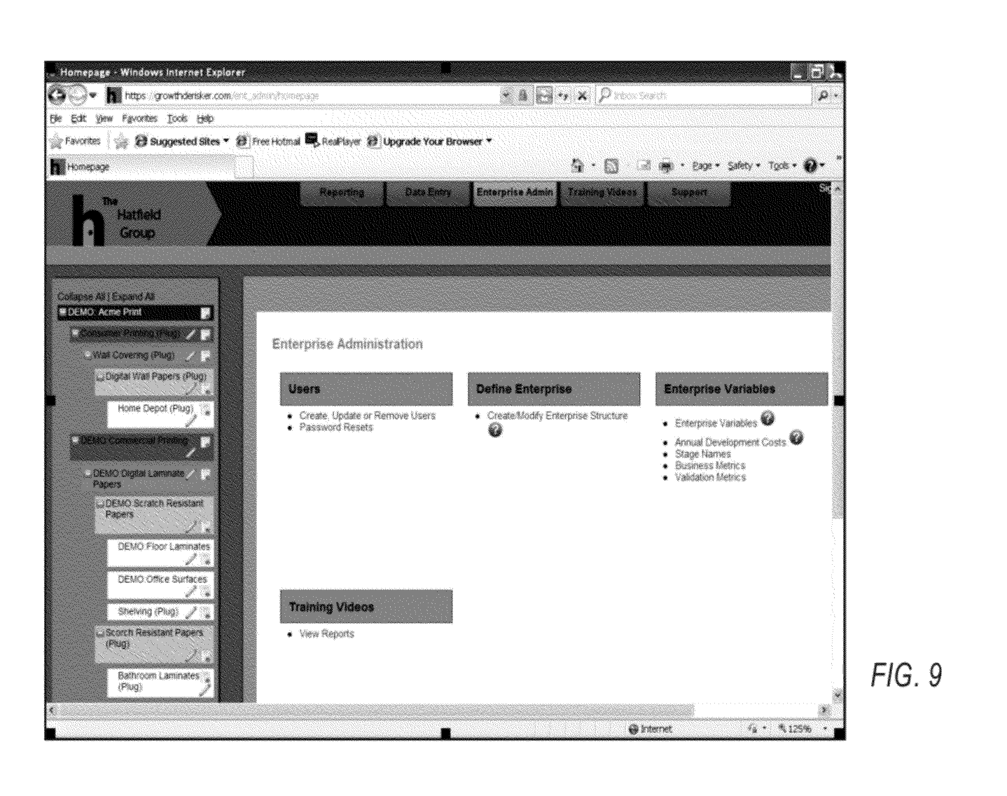

FIG. 9 is a screen shot a user interfaces with during the enterprise administration module;

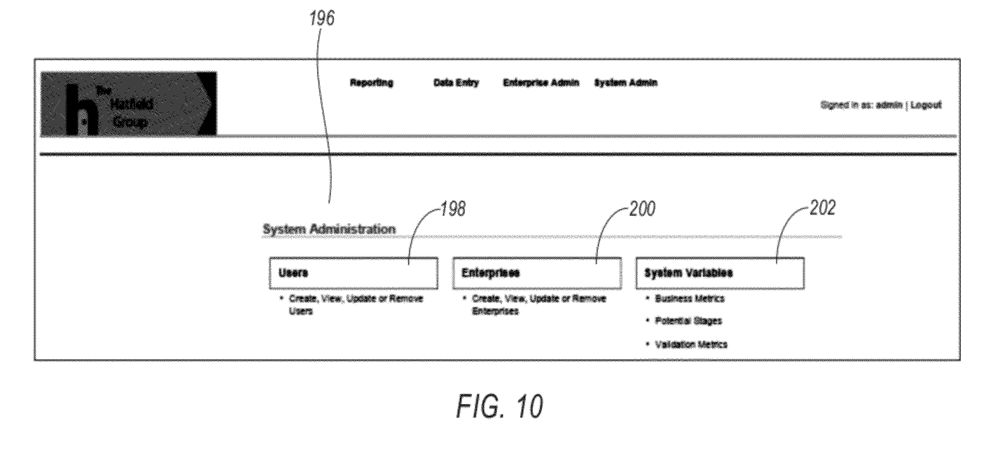

FIG. 10 is a screen shot the user interfaces with during the system administration module;

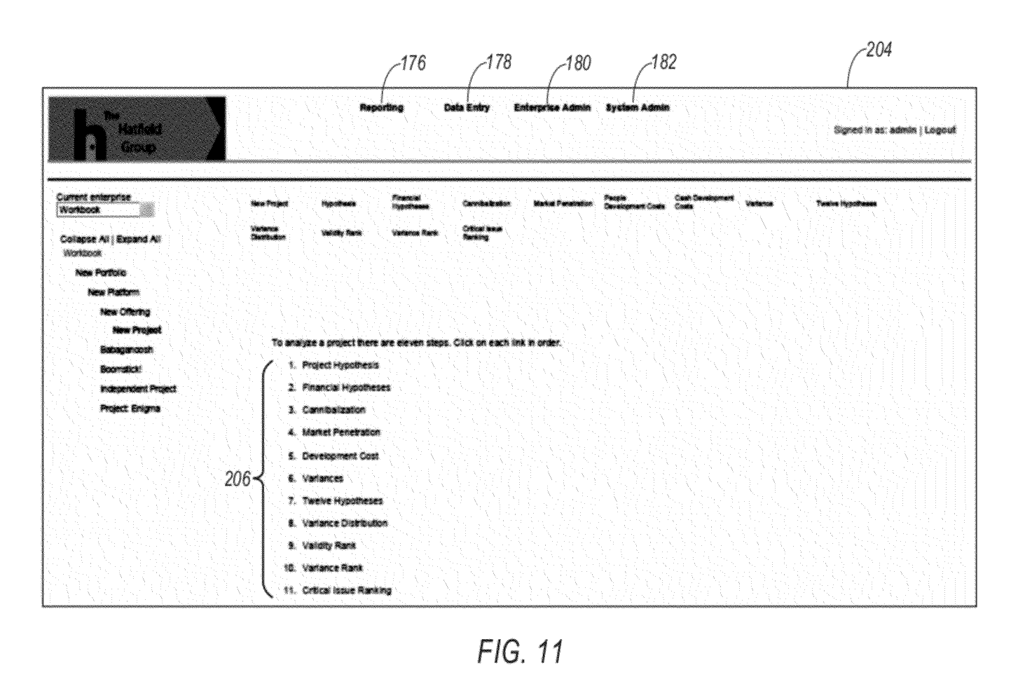

FIG. 11 is a screen shot a user interfaces with during the data entry module, showing eleven steps this invention employs to analyze a new project;

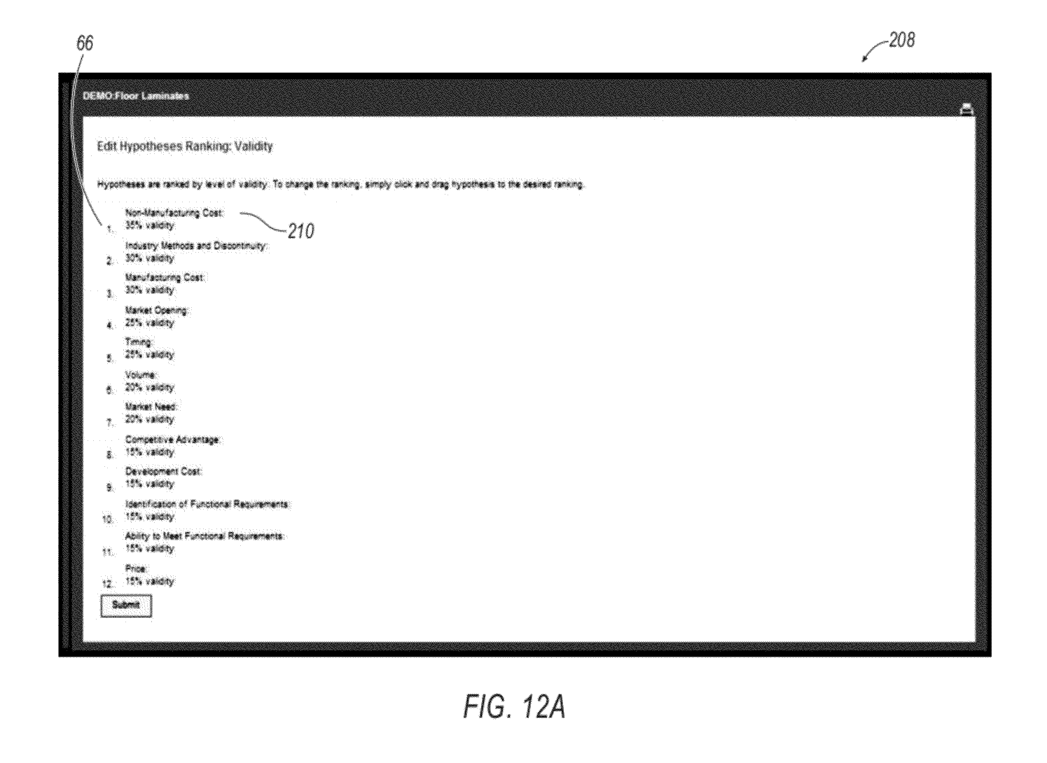

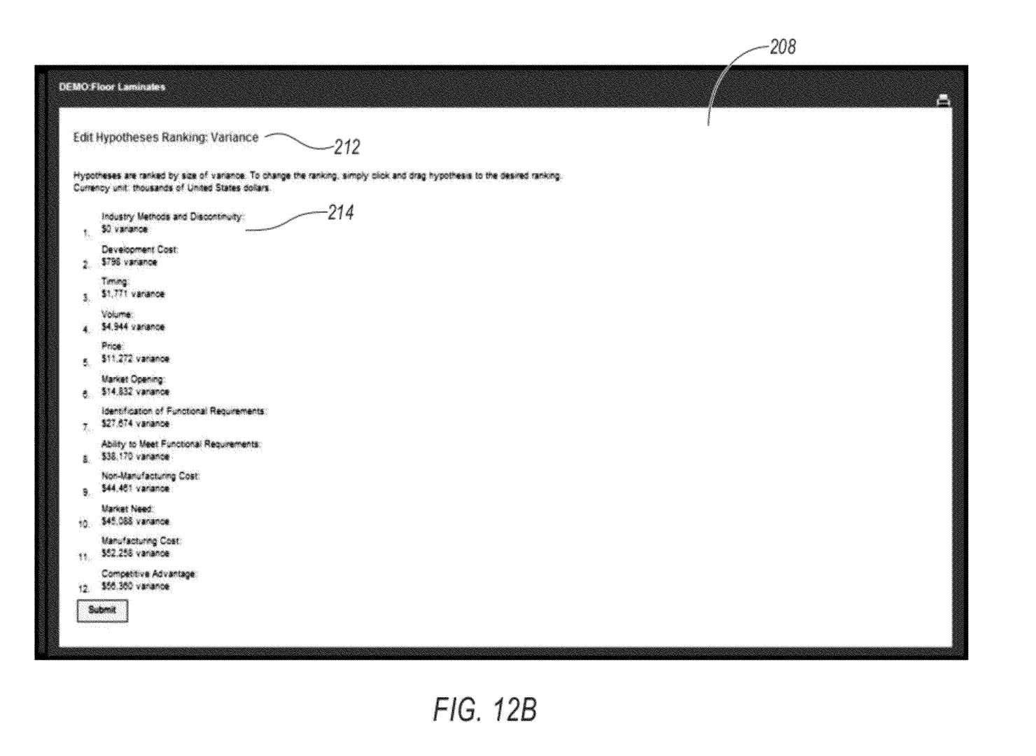

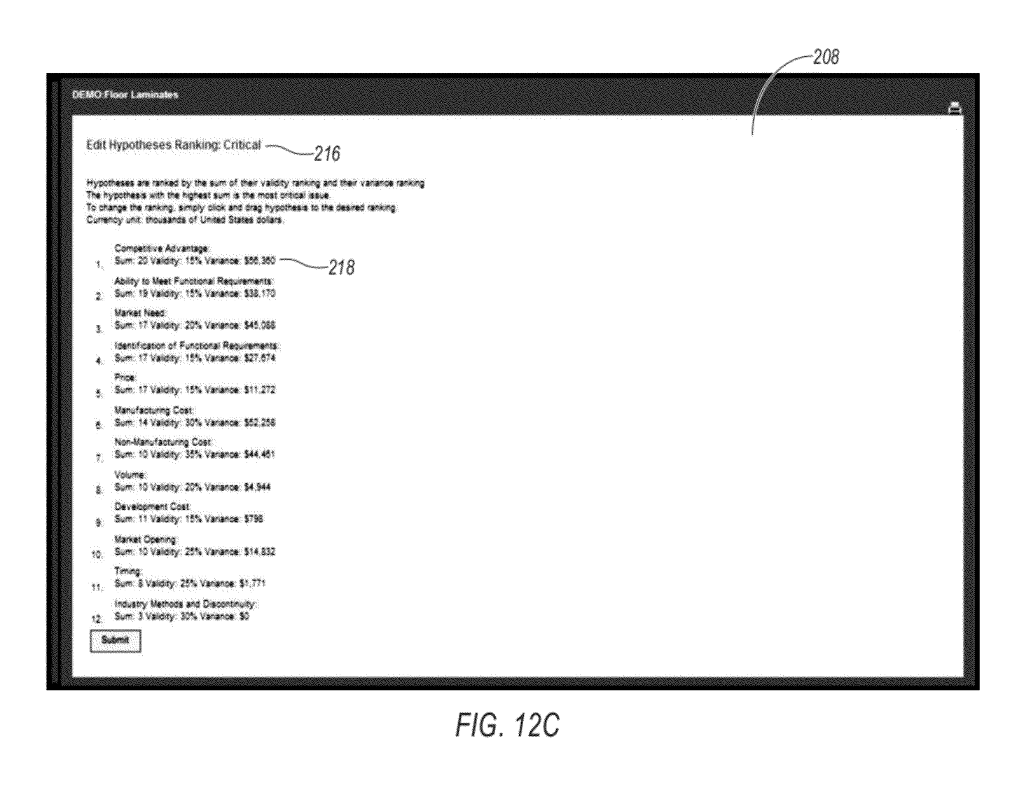

FIG. 12A illustrates a screen shot a consumer interfaces with in order to view and modify the hypothesis ranking validate feature;

FIG. 12B illustrates a screen shot a consumer interfaces with in order to view and modify the hypothesis ranking variance feature;

FIG. 12C illustrates a screen shot a consumer interfaces with in order to view and modify a critical ranking of the hypothesis stated variables;

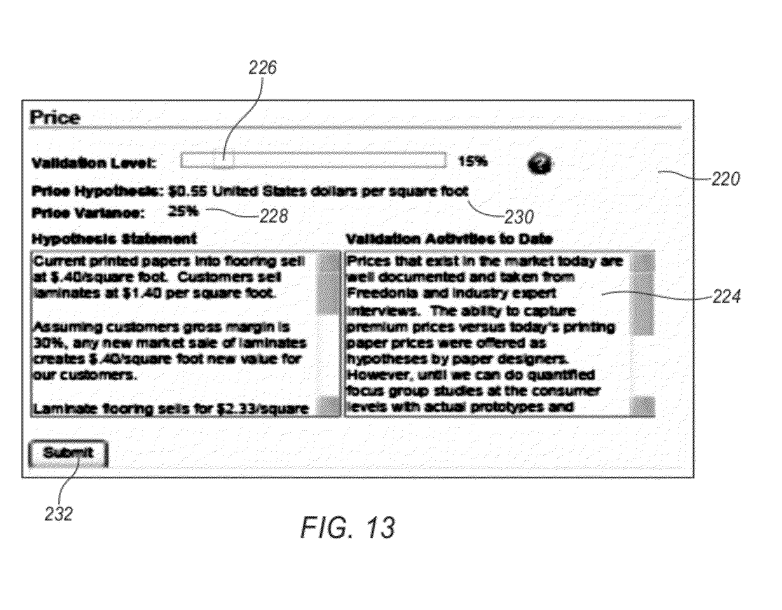

FIG. 13 illustrates a screen shot a consumer interfaces with during the data entry module;

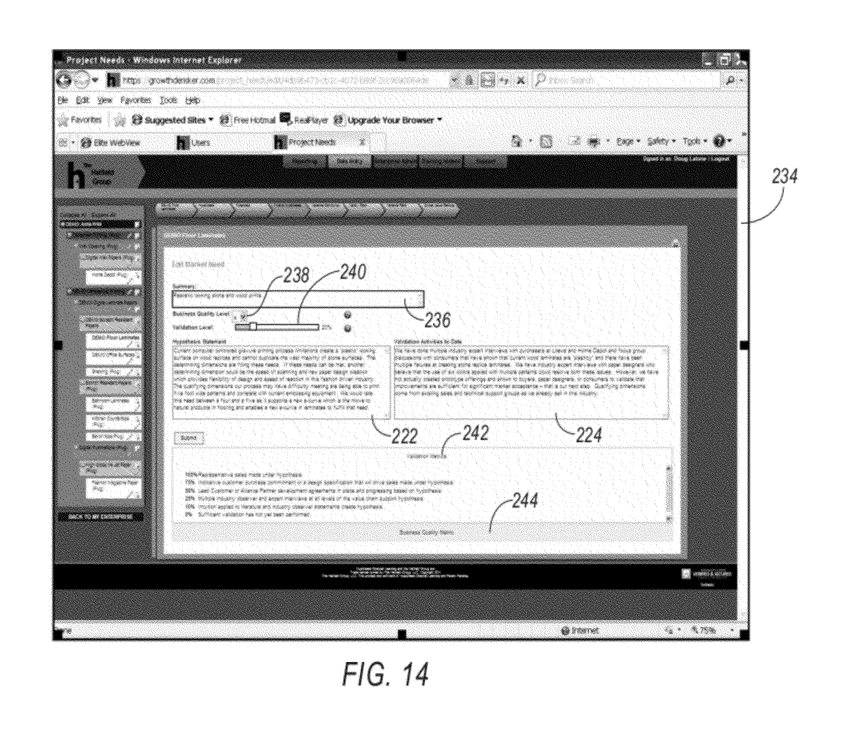

FIG. 14 illustrates a screen shot a consumer sees when interfacing with the data entry module;

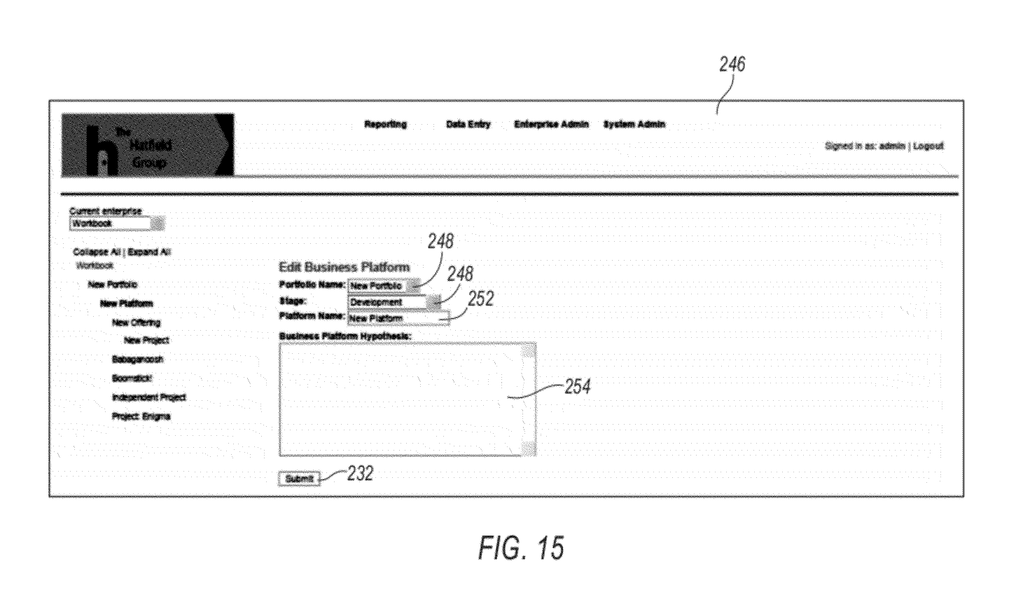

FIG. 15 illustrates a screen shot a consumer sees when interfacing with the data entry module;

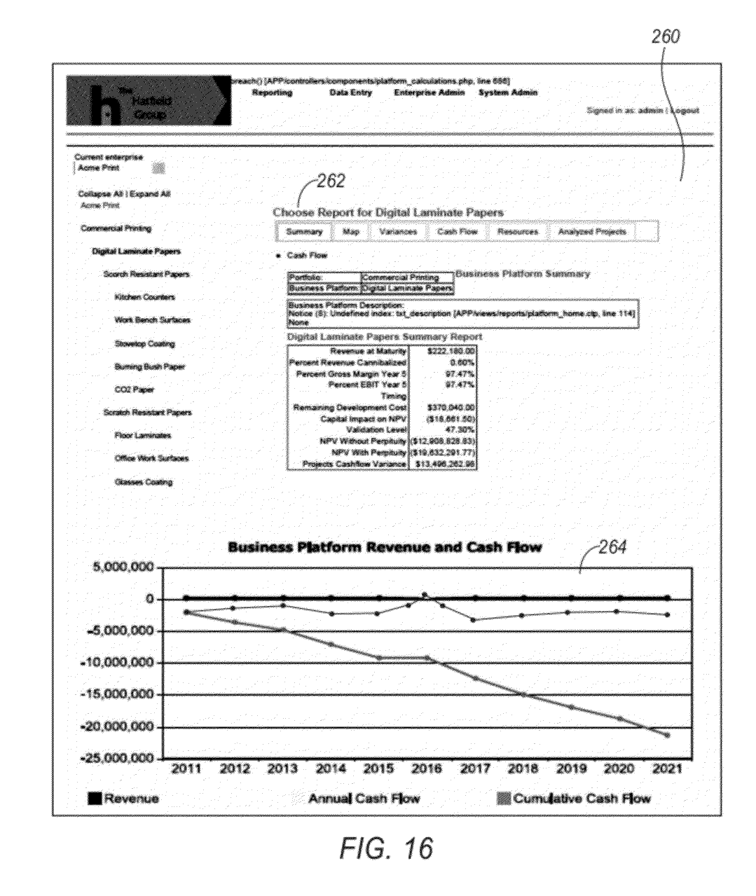

FIG. 16 illustrates a screen shot a consumer interfaces with during the reporting module;

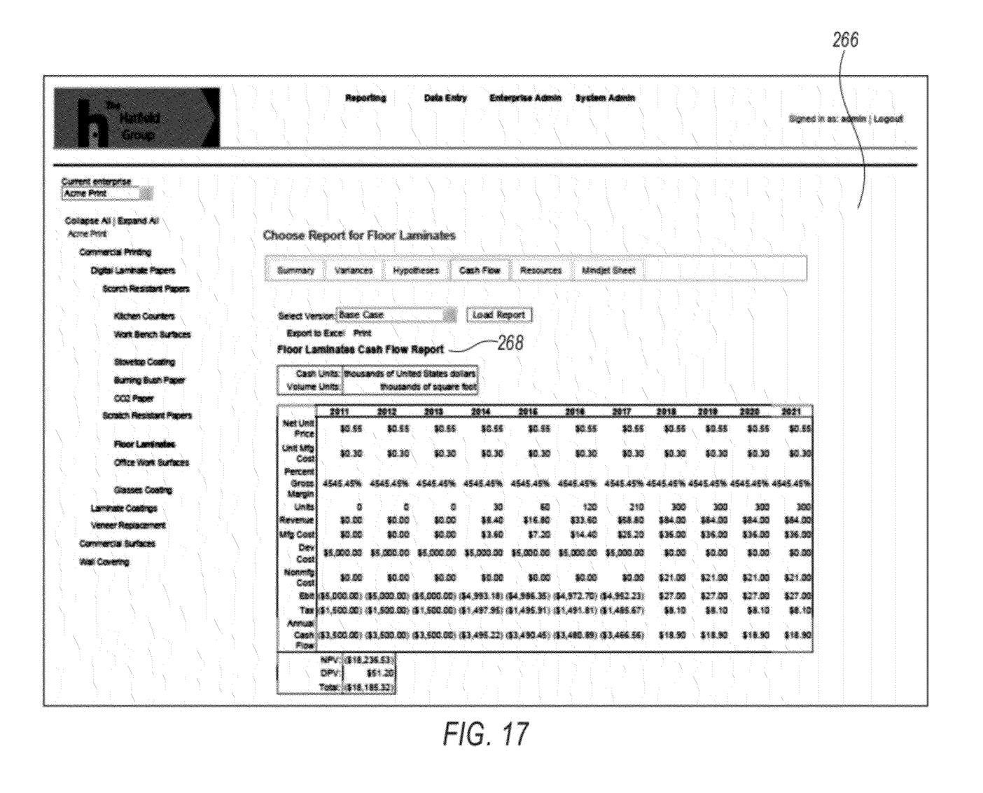

FIG. 17 illustrates another screen shot a consumer interfaces with during the reporting module;

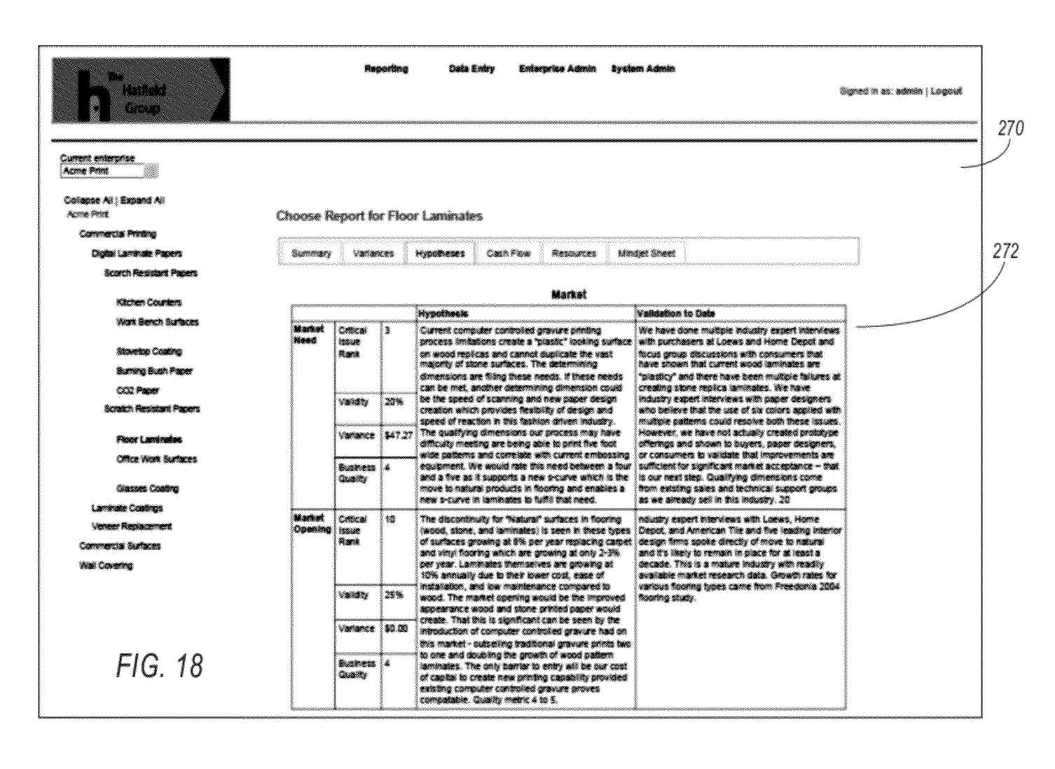

FIG. 18 illustrates another screen shot a consumer interfaces with during the reporting module;

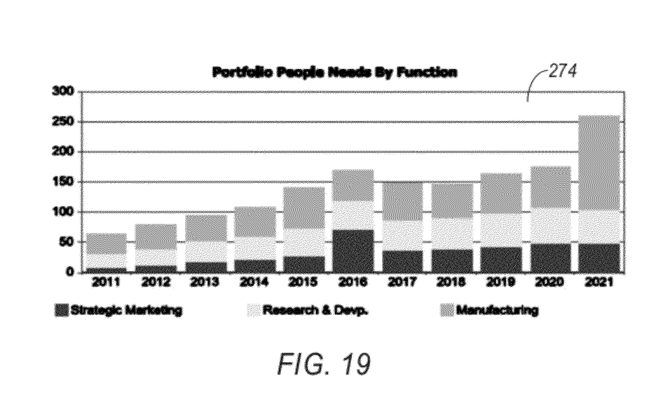

FIG. 19 illustrates another screen shot a consumer interfaces with during the reporting module, showing a graph of manpower needs a new business opportunity may require;

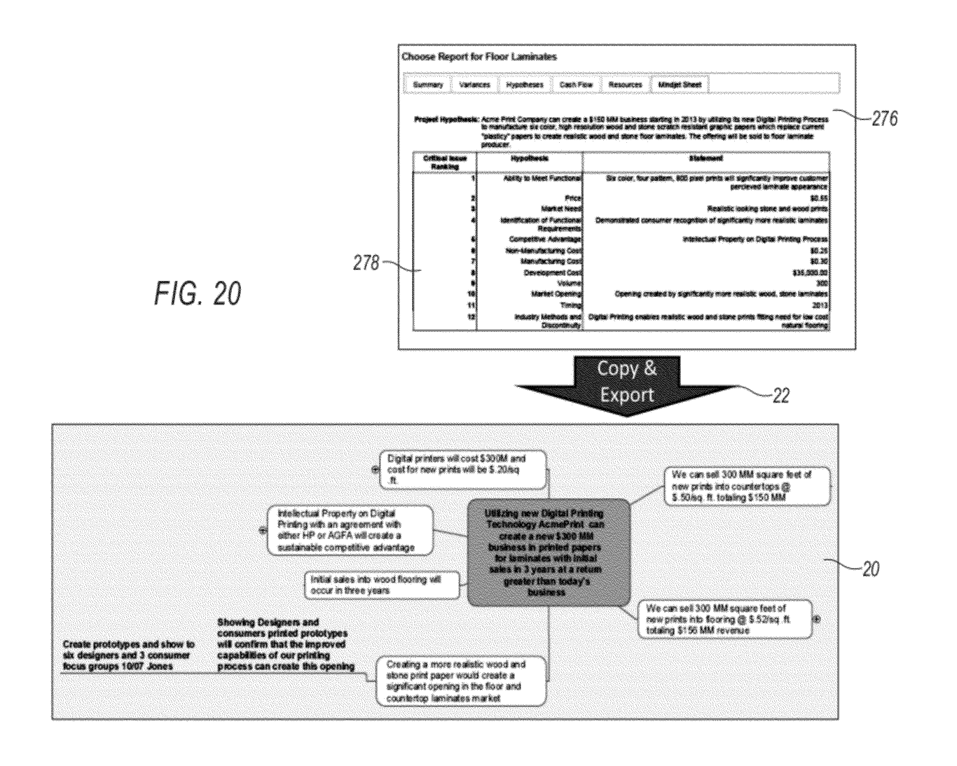

FIG. 20 illustrates a screen shot a consumer interfaces with during the reporting module, further illustrating exporting data to another system;

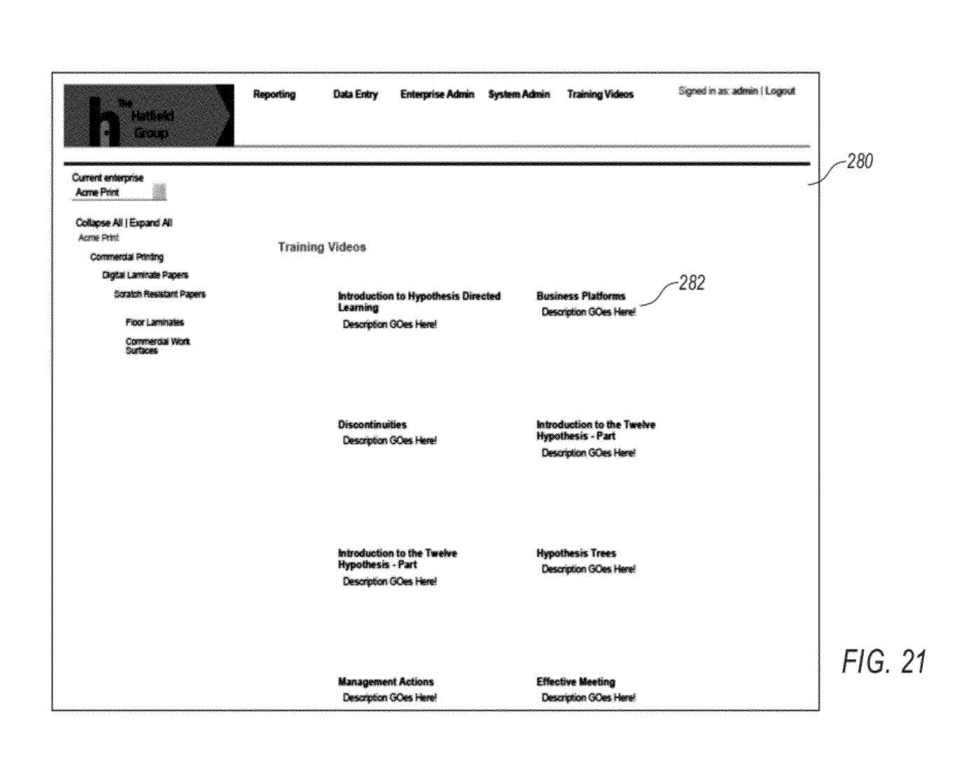

FIG. 21 illustrates a screen shot a consumer interfaces with during the training videos module.

### DETAILED DESCRIPTION OF THE PREFERRED EMBODIMENTS

A business risk assessment system 10 is operable to identify and reduce the risk of new business opportunities and can be implemented across a platform where remote users can seamlessly input and exchange information that furthers the process of identifying potential business opportunities and enhancing quality deal flow within an organization. This system 10 may include a computing device 12, a user interface 14 for inputting data about a potential business opportunity, a training interface 16 for aiding users to use the system 10, and a user output interface 18. The system 10 may also include a client's data and business management system 20 that receives exported data 22 from the computing device 12.

The system 10 may be connected to a communication network or cloud 24 which in turn may be connected to a plurality of remote users 26 who may connect with one another, and with the computing device 12. A trainer 28 may communicate through the training interface 16 via the computer 12 to one or more remote users 26. Likewise, a remote trainer and consultant interface 30 may be connected to the cloud 24 and computing device 12 so as to allow a remote trainer and/or consultant 32 to operate remotely and engage the system 10. The remote trainer 32 could be management that participates in remotely to engage the system 10 and to oversee its employees. It will be appreciated that the system 10 may have more or fewer than the components described above.

The computing device 12 includes a processor 34, a data store 36 and a software program 38. The software program 38 contains algorithms to store and manipulate data for de-risking business opportunities and preferably includes a hypothesis driven algorithm that is employed to scalably process and analyze hypothesis stated variables that are utilized for ranking and assessing risk to a given business opportunity. The software program 38 is further operable to generate the user interface screen that the user sees at the user interface for data input 14. It will be appreciated that data entry, data reporting and training could take place at any time and anywhere internet access is available; thus, allowing the user at the remote interface 26 to have the same access as a user 15 that is located at an on-site user interface 14. Thus, the system 10 is scalable and has broad reaching accessibility so users can be positioned at many locations yet feel they are together.

System 10 further allows multiple remote users 26 to simultaneously study deal data that is housed in the data store 36. This feature provides certainty and minimizes ambiguity that may be associated with the metrics of a particular new business opportunity.

FIG. 2 illustrates a traditional linear stage-gate process 40 for analyzing a new business opportunity. Traditionally, a new business opportunity would begin with a business discovery 42 and a series of stage-gates 44, 46, 48 and 50 that collectively define a process 40 wherein each such gate forms a decision point of the process. Various stages 52, 54, 56, and 58 include various uncertainties 60, each of which bearing their own levels of risk, unknowns and concerns to an organization. Many of these uncertainties and their order of resolution are based on past product developments and they may not be very well defined even though they may remain a highly critical issue.

FIG. 3A illustrates a hypothesis directed learning iterative stage-gate process 62 that employs the present invention. The process 62 begins with a discovery 42 and a series of gates 44, 46, 48 and 50. The process 62 is iterative and between each gate the process can be improved by identifying risks, addressing the problems associated with those risks, recalculating and prioritizing risks, and repeating said steps as necessary until the process 62 is complete.

Spider diagrams 64, 68, 70 and 72 provide a visual output of the metrics associated with a predetermined set of hypothesis stated variables 66 which are in turn quantified visually on the spider diagrams. The process 62 advances from an initial stage-gate 44 to a final stage-gate 50. At each step metrics representing the levels of uncertainty or validity that are associated with the new business opportunity are plotted causing the spider diagram 64 to be updated iteratively throughout the process 62.

With reference to FIG. 3B, a spider diagram 68 is shown in an early stage of the process, while spider diagrams 70 and 72 depict spider diagrams at the end of the hypothesis directed learning iterative stage-gate process 62. When the spider diagram 72 is fully completed and filled in, then the iterative process has been completed which now depicts a higher level of certainty and lower level of risk about the new business opportunity that a company may now be considering implementing or purchasing.

Each spider diagram 64, 68, 70 and 72, contains twelve hypothesis stated variables 66 that represent a category of information management could consider as a relevant business variable for a potential new business enterprise or project. Examples of such hypothesis stated variables 66 include, but are not limited to, ability to meet functional requirements, price, market need, identification of functional requirements, competitive advantage, non-manufacturing costs, manufacturing costs, development cost, volume and market opening. It will be appreciated that company management could desire more or fewer hypothesis stated variables 66; thus the business risk assessment system 10 can be flexible to accommodate the preferred criteria a management may want to consider. The system 10 is operable to allow the spider diagram 68 to be modified to have input, to process, and then to provide an output diagram via a spider diagram, selected variables that are determined to be important by management.

A spider diagram includes plotted data 74 which represents the level of certainty or validity at a particular stage of the iterative process. The greater the degree of certainty (see spider diagram 72), the higher level of certainty management may consider. The goal is to increase the level of certainty at each stage-gate 44, 46, 48 and 50, so as to add clarity and reduce the level of potential risks associated with that new business enterprise. The system contains criteria for establishing the level of certainty or validity for each of the hypothesis stated variables.

FIG. 4 illustrates one aspect of the present invention where a system 80 for managing risk having a computing device 12 is depicted and is configured to perform various tasks. The computing device 12 utilizes the software program 38 which communicates with the user interface for data input 14 which in turn allows input data to be stored in a data base or data store 36. The system 80 for managing risk having a computing device is configured 82 to receive data into a computer hypothesis software program and save the data in a data base 84. The computer hypothesis software program 38 includes an hypothesis driven algorithm that prioritizes financial analysis of each hypothesis stated variable's impact on the value and its level of certainty which creates an output that identifies the most critical issues that need to be addressed and resolved at a given point of the iterative stage-gate process 62.

The computing device 12 is further configured to calculate cash flow, present value in variances for a new business opportunity 86. The computing device 12 is further configured to assign level of validity and variances to a set of hypothesis stated variables 88. These are the hypothesis stated variables 66 referenced in the discussion of FIGS. 3A and 3B. The hypothesis stated variables 66 can include, but are not limited to, price, volume, manufacturing cost, non-manufacturing cost, development cost and time it takes to get to market.

The computing device 12 is further configured to prioritize the hypothesis stated variables from the lowest level of validity and the highest impact on value, and identify the most critical issues to be addressed in the new business 90. A user of the system 80 may change the priority based upon their desired level of importance of hypothesis stated variables 66.

The computing device 12 is further configured to aggregate each new business project's commercial timing, business attractiveness, revenue at maturity, level of validity, relatedness by offering platform and current resources at a business platform level 92. By aggregating this data, a user may observe metrics about a plurality of new business projects on a scalable basis which adds certainty and reduces ambiguities that may be associated with looking at business opportunities, separately.

The computing device 12 is further configured to create a business platform map 94 that allows a user via the output interface 18 (FIG. 1) to visually see representations of how a potential new business project may impact a company.

The computing device 12 is also configured to create actions, assignments, timing, and milestones for a de-risking of the business platform 96. This action becomes part of the iterative stage-gate process 62 that allows problems to be resolved at the different gates 44, 46, 48 and 50. The system 80 allows for data to be updated into the system so that the risks associated with a particular hypothesis stated variable 66, can be reassessed and reprioritized.

The computing device 12 is further configured to aggregate project cash flows, variances, levels of invalidity, and resources and offering platform cash flows at the business platform, business portfolio and the enterprise level 98. This feature allows a user with the aid of the computer on a highly scalable basis to consider important platform, portfolio and enterprise level data so as to allow management to comprehend the larger picture of how a new business opportunity may fit into its organization.

The computing device is also configured to provide forecasts of financial results, resource needs, capital needs, project plans and portfolio risk 100. By providing forecasts, a user can better appreciate the financial component of a new business opportunity.

The computing device 12 is further configured to provide a link of the underlying hypothesis stated variables and their level of validity behind forecasts, plans and portfolio risk 102. By this linking feature a greater certainty to the data is realized which increases confidence of the system 80.

The computing device 12 further sorts each business opportunity and prioritizes them by preferred criteria to optimize a portfolio 104. Sorting the business opportunities allows management to look at multiple business opportunities at one time, yet knowing that the opportunities are sorted based on the user's preferred criteria.

It will be appreciated that the computing device 12 may be configured to provide other tasks and could even be configured to remove some of the aforementioned features.

FIG. 5 illustrates another approach to the business risk assessment system 10 and the steps that are employed by the computing device 12. Through the aid of the computing device 12, the system 10 enables rapid identification and prioritization of critical issues and effective validation and implementation activities that result in a business platform of higher value with reduced risk that is ready for implementation. A computing device 12 is configured to create financial and path portfolio data 110. This is accomplished by a user inputting data into the software program 38 which in turn is stored in the data store 36. A data entry tab is provided at a user interface screen which allows a user to input data that is relevant to that particular business prospect. Because the system 10 is standardized, the same data points are collected for each new business opportunity which provides for consistency in the later discussed reporting process.

With continued reference to FIG. 5, the system for managing new business development 10 further includes a computing device 12 that is configured to utilize hypothesis stated variables to create an action plan and to aid in the de-risking of potential new business 112. Next the computing device 12 is configured to capture financial, resource, capital and risk components 114 of the new business opportunity. This information is captured in view of the data that has been input by the user during the workup of the project. The computing device 12 is further configured to capture and link the hypothesis stated variables to other data systems 116. For example, data as processed or stored in data store 36 can be seamlessly linked to project level de-risking activities to an overall portfolio analysis at the enterprise, business and business platform levels. By linking to these other levels, the system 10 is operable to be readily scaled so as to be easily analyzed by an organization. The computing device 12 is operable to a link 116 to several different data sets including, but not limited to, a financial results, resource and capital forecasting data set 118, a project planning data set 120, and a portfolio optimization and risk management data set 122. These data sets 118, 120 and 122 may be housed in the data store 36, a cloud 24, or a data center 124. Data can then be exported 126 to a client's data and business management system 128 or to viewable reports 130 which in turn can be transmitted to the human output interface 18 (see FIG. 1). Thus, the viewable reports 130 can be in many forms and can even be tailor fit to accommodate a user's preference.

FIG. 6 illustrates the basic steps for a system for managing new business opportunities. The system is accomplished through use of the software program 38 and its associated computing device 12. A process for assessing business risk 132 includes the steps of identifying a hypothesis of opportunity 134. This opportunity could include adding on a new product line, “bolting-on” a new enterprise to an existing business, or acquisition of an entirely new company, to name a few examples. The system for assessing business risk 132 next includes receiving data associated with the hypothesis of opportunity 136. The receiving data step 136 could include a user 15 inputting data through interface 14. The next step includes assessing risk in the new business opportunity 138 by issuing metrics to certain predetermined characteristics of a new business. For example, such characteristics could include, but not be limited to, industry methods and discontinuities, market needs, market openings, competitive advantages, identification of functional requirements, whether or not functional requirements have been met, price, volume, manufacturing costs, non-manufacturing costs, developmental costs and commercial timing of introduction of a new enterprise into the marketplace.

The next step for the system 132 for assessing business risk includes receiving a priority of critical issues 140. This step allows management to prioritize those business variables which it deems to be most important. And finally, the system 132 for assessing business risk includes creating de-risking plans and action items 142. The resulting plans and actions allow management to deal with resolving the critical issues that remain open during the stage-gate process. It will be appreciated that the system 132 for assessing business risk could interface with a computing device 12 so as to provide scalability and robustness of the stage-gate process.

FIG. 7A illustrates an alternative system 150 of the present invention. The system 150 includes a tangible computer readable medium embodying computer-executable instructions for automating hypothesis directed learning 152. The computer readable medium could be a disc, drive, memory, or other device that is operable to store executable instructions. The executable instructions are operable to automate a system for managing the risk that may be associated with a new business opportunity. The system 150 further includes calculating, using a calculation algorithm, a financial characterization of costs, business returns, level of validity, uncertainty, variation in returns and resource planning 154. The calculation algorithm could be performed by a software program 38 which in turn is operable to a process data that is input into a computer 12. It will be appreciated that the calculating feature 154 of the system 150 may include calculating other variables, while not including all the variables previously mentioned. The system 150 further includes outputting to a display output screen, data and calculating results to hierarchically identify risk, resource requirements and expected value 156. It will be appreciated that a user can manipulate the system 150 to output various preferred bits of information so as to allow the user to better assess a business opportunity.

FIG. 7B illustrates an alternative system 160 that includes a tangible computer readable medium embodying computer-executable instructions 162. The computer-executable instructions can be from a software program that is either hosted on a local computer, or remotely. The system 160 further directs the input of new business opportunity hypotheses, activates to validate those hypotheses, considers levels of validity and uncertainty surrounding those hypotheses, considers financial inputs for financial results and variances, prioritizes critical issues, and propagates plans, actions and resources to de-risk opportunities in order to focus portfolio optimization 164. The inputting of this information can be accomplished by a user interface input 14 which stores the input information in a data store 36.

The system 160 next calculates expected financial results, variances, and aggregates expected financial results, resource needs, capital needs, variances, and validates at multiple levels of an organization 166. The various levels of an organization could include a project offering platform, a business platform, a portfolio or enterprise platforms. The calculation step can be accomplished by the software program 38 pulling data out of the data store through the aid of the processor 34.

The system 160 further creates graphic, textual and tabular reports of forecasted financial results, resources, capital and project plans and portfolio risk and optimization for the viewing through a human interface 168. The system 160 next generates outputs from the previous steps so that they can be exported to other software for further calculations and analysis 170. The outputs can be viewed locally by a user at an output interface 18 or could be pushed to a client's data and business management system 128.

The system 160 is further operable to display various training, testing and coaching points so as to allow users to accomplish and understand their use of the system described above 172. A unique aspect of the system 160 is that a trainer 28 via a training interface 16 can monitor users of system 10 so as to assist them in efficiently utilizing the tools they have been provided. And finally, the system 160 administers and reports user actions of the aforementioned steps to set organizational structure, set variables that are desired to be constant among all projects, maintain security and to track user progress 174. The computer-executable instructions 162 are operable to direct 164, calculate 166, create 168, and generate 170, display 172 and administer 174 a unique set of executable instructions that collectively, once executed, allow a user to assess new business opportunities. It will be appreciated that more or fewer executable instructions could be employed so as to gain desired results.

FIG. 8 illustrates various modules a user may see when operating the software program 38. Various figures described hereafter depict an output screen that a user may see when working in these various modules. It will be appreciated that the software program 38 may include more or fewer modules, but exemplary modules could include a reporting module 176, a data entry module 178, an enterprise administration module 180, a system administration module 182, a video training module 184, a planning module 186, and a portfolio analysis module 188.

The reporting module 176 allows a user to see graphic and data summaries regarding cash flows, capital, resources, variances, and validity for projects, offering platforms, business platforms and portfolio of business platforms. The user at output interface 18 is able to select the information they would like to see reported in a variety of different ways.

The data entry module 178 allows a user at interface 14 to input the twelve hypotheses 66. Once the data has been input the program causes the same to be stored and then later calls upon a data for further action. It will be appreciated that in order to analyze any particular new business opportunity, the software program 38 analyzes, preferably, twelve steps. They include project hypotheses, base financials, cannibalization, market penetration, people development costs, cash development costs, variances, twelve hypotheses, variance distribution, validity rank, variance rank, and critical issue ranking. It will be appreciated that in order to analyze a new business opportunity more or fewer steps could be employed, however it has been found to be preferred that the aforementioned twelve hypotheses, be employed.

With continued reference to FIG. 8, the enterprise administration module 180 provides a user's tab, a defined enterprise tab, an enterprise variables tab, and a training videos tab. These are the top level functions a user may interface in order to use the program 38. A system administration module 182 allows management to control who has access to the various aspects of a program 38. The video training module 184 includes an interface screen (FIG. 21) that allows users 15 both locally and remote 26, to train. The program 38 keeps track of which videos a user has watched thus providing a tracking system for management to make sure employees have been trained. A remote trainer interface 30 and person 32 can help the users who may have further questions after having viewed the training videos. Users may further follow up with the remote trainer and consultant 32 so that the users can efficiently operate the software program 38.

The software program 38 includes a planning module 186 that allows users to develop a plan for moving forward with a new business opportunity. The planning module 186 allows the user to combine like critical issues across projects into aggregated critical issues for resolution. The planning module 186 then allows the user to take each prioritized critical issue, identify an action for its resolution, the resources needed for that action, a milestone that indicates when the action is complete with timing, and an assigned person or team accountable for accomplishing the action and meeting the milestone. The estimated cost to accomplish the action along with the estimated resulting reduction in variance in expected value and increase in validity accomplished by the action can be utilized by management to prioritize the use of resources between various proposed actions in the organization. The module 186 also tracks the accomplishment of milestones and their timing to evaluate individual and team performance.

And finally, the portfolio analysis module 188 allows a user to collectively observe all of the opportunities in a particular enterprise, portfolio, business platform, or offering platform. The portfolio analysis module 188 allows the user to select criteria by which to prioritize the value of portfolios, business platforms, offering platforms, or projects. The module 188 allows users to identify resource or capital limits within an enterprise, portfolio, business platform, or offering platform. It then allows a user to sort opportunities within these entities by the selected criteria, identifying at what level of the prioritization the critical resource limits are surpassed. This allows management at each entity level to identify through prioritization and limits the actual optimal portfolios, business platforms, offering platforms, and projects it can afford to implement within current resource and capital restraints.

FIG. 9 illustrates a screen shot a user sees when the enterprise administration module 180 is launched. Users can be added or deleted 190 by management. Likewise, management may modify an enterprise structure and its associated variables 192 through an input window. Management may also be able to see video reports 194 in order to track user's progress in learning how to use the system 10.

FIG. 10 illustrates a screen output for system administration 196 that a user interfaces with once the system administration module 182 has been launched. Here management may control 198 users within the system, generate new enterprise opportunities 200, and set the system variables 202. This is a top level administration screen that general users will not utilize.

FIG. 11 is a project screen 204, a user sees while in the data entry module 178. This screen depicts the eleven steps 206 the process analyzes for each potential new business opportunity. A user may click on each of these eleven steps and in turn they will be prompted to undertake various tasks such as inputting information and data. The eleven steps 206 include: project hypothesis, financial hypotheses, cannibalization, market penetration, development cost, variances, twelve hypotheses, variance distribution, validity rank, variance rank, and critical issue ranking. It will be appreciated that more or fewer steps could be undertaken

FIG. 12A illustrates a screen shot 208 a user sees while in the data entry module 178. Here the user sees the various module tabs such as the data entry module 178 (FIG. a). The hypotheses for ranking validity 66 are shown ranked in order of descending validity. Here, non-manufacturing cost 210 has a 35% validity. To change this ranking a user may grab and move them by clicking and dragging on this screen.

FIG. 12 B illustrates a screen shot 208 a user sees while in the data entry module 178. In this screen, the twelve hypothesis stated variables 66 are ranked by level of variance 212. The variances of hypothesis stated variables are shown ranked by size of variance with the smallest variance at the top. A user can change the ranking by clicking and dragging the hypothesis to the desired ranking. Here, Industry Methods and Discontinuity 214 have a $0 variance. This data directly correlates to that particular component as shown in the spider diagrams of FIG. 3B.

Another unique aspect of the present invention is that it provides an output screen 208 called a critical issue ranking 216 as is shown in FIG. 12C. This screen allows a user to see the hypothesis stated variables ranked by the sum of their validity ranking and their variance ranking. The hypothesis stated variable with the highest sum is the most critical issue that should be addressed by the organization. In order to change the critical ranking, the user can click and drag the hypothesis stated variable to the desired ranking. Here, the competitive advantage hypothesis 218 is ranked the highest with a total ranking of 20. The validity for the competitive advantage hypothesis is 15% and the variance is $56,360. This novel ranking system allows users to identify critical issues in their level of importance.

FIG. 13 depicts a screen shot 220 a user would see when interfacing with the data entry module 178. This is an interactive screen which allows a user to input information in a hypothesis statement 222 where key information about an enterprise can be input. The user also inputs information about validating activities that have transpired to date 224. A user may set or indicate on a task bar 226 the appropriate validation level and then input the price variance 228 and price hypothesis 230. Once this data has been input, the user hits the submit button 232 and the data is uploaded to the data store 36. The process for inputting data for the various hypothesis stated variables 66 is similar to that as discussed in FIG. 13 for the price hypothesis stated variable. This is accomplished by the system 10 having a user interface for data input 14.

FIG. 14 illustrates an output screen 234 a user sees during the data entry module 178. This screen includes a summary 236 of what the business opportunity pertains to, a business quality level 238, a validation level task bar 240 and the previously discussed hypothesis statement 222 and validation activities section 224. The output screen 234 further includes validation metrics 242 and business quality metrics 244 which provide the user with useful criteria for evaluating the opportunity. The validation metrics 242 define for the user the percentage level of certainty or validity that is considered within the system 10. Examples of such validation metrics include, but are not limited to, secondary research, laboratory testing, representative sales, prototype creation and testing. It will be appreciated that company management could desire more or fewer validation metrics as shown in 242; thus the business risk assessment system 10 can be flexible to accommodate the preferred number of validation metrics and their actual content that a management may want to consider. These metrics are correlated with the data that is output in the spider diagrams shown in FIG. 3B. Such outputs allow a user to visually see the percentage of certainty of how complete the stage-gate process is at a particular point in time.

FIG. 15 illustrates a screen shot 246 a user sees when in the data entry module 182. This screen provides an interface for a user to begin entering data for a new business opportunity into an existing business platform. The user inputs the portfolio name 248, the stage of development 250, and the platform's name 252. The business platform hypothesis information 254 can then be input by the user which is saved after the submit button 232 is depressed which saves the data to the data store 36.

FIG. 16 illustrates a screen shot 260 a user sees when interfacing the reporting module 176. The user may choose a report 262 which then causes to be automatically generated a report and its associated data. The data may be depicted in graphs 264.

FIG. 17 illustrates another screen shot 266 which illustrates a cash flow report 268 with projections. The data depicted in this report is generated by the various assumptions and inputs that occur during the prior data entry stages.

FIG. 18 illustrates a screen shot 270 depicting a market analysis report 272 that would be seen in the reporting module 176. This report 272 pulls together various strategic bits of information management may consider when looking at a particular business opportunity. For example, market need, critical issue ranking, validity, variance, business quality, and the hypotheses and validation to date data are all captured in this report 272.

FIG. 19 is a graph 274 that a user would see in the reporting module 176. The graph 274 breaks down the anticipated needs of human capital during the strategic marketing, research and development and manufacturing stages for a potential new business enterprise. The system 10 thus is operable to provide reports 272 that allow management to forecast human capital needs based on function.

FIG. 20 depicts a project report 276 where the critical issue rankings 278 have been prioritized along with their associated hypotheses and statements. Data can be exported 22 (see FIG. 1) to a client management system 20. Thus, reports 276 can be linked to other systems 20 in a seamless fashion so as to enhance scalability and robustness of the system 10. System 20 is but one example of a system to which the reports 276 can be exported. It will be appreciated that the project report 276, and other reports, could be delivered to a user output interface 18 (see FIG. 1) such as a computer screen or other digital device.

FIG. 21 illustrates a training video output screen 280 that a user would see when the video training module 184 is launched. Remote users 26 have access through a communication network 24 to the video training module 184. This feature allows remote users to be educated about the system 10 while being offsite. Various videos 282 are provided and the review of same is tracked by the system 10 so that management or others can keep track as to who has completed their training assignments. Test assignments could be provided thus providing a user with real-life opportunities for learning how to use the system.

It will be appreciated that the aforementioned process and devices may be modified to have some steps removed, or may have additional steps added, all of which are deemed to be within the spirit of the present invention. Even though the present invention has been described in detail with reference to specific embodiments, it will be appreciated that various modifications and changes can be made to these embodiments without departing from the scope of the present invention as set forth in the claims. Accordingly, the specification and the drawings are to be regarded as an illustrative thought instead of merely a restrictive thought of the scope of the present invention.

What is claimed as new and desired to be protected by Letters Patent of the United States is:

1. A method for assessing risk in new business opportunities comprising:
a. identifying a hypothesis of opportunity, its validity and financial impact for business opportunities
b. receiving data associated with the hypothesis of opportunity, its validity and financial impact;
c. receiving a priority of critical issues; and
d. creating de-risking plans and actions.

2. The method for assessing risk in new business opportunities as claimed in claim 1, further comprising a computing device and which prompts, via the computing device, a user to provide the data using a web based interface.

3. The method for assessing risk in new business opportunities as claimed in claim 1, further comprising prioritizing the critical issues based on risk, validity and impact on value.

4. The method for assessing risk in new business opportunities as claimed in claim 1, further comprising identifying new business opportunities, and then inputting data through a user interface into business and offering platforms.

5. The method for assessing risk in new business opportunities as claimed in claim 1, further comprising reducing the project risk associated with a new business opportunity.

6. The method for assessing risk in new business opportunities as claimed in claim 1, further comprising the step of inputting financial and risk information into a portfolio management system for opportunity prioritization and selection.

7. The method for assessing risk in new business opportunities as claimed in claim 1, wherein the hypothesis of opportunity includes at least one of the following variables: market competition, market opening, market need, identification of functional requirements, ability to technically satisfy functional requirements, price, volume, manufacturing cost, non-manufacturing cost, development cost and time to market.

8. The method for assessing risk in new business opportunities as claimed in claim 1, further comprising the step of generating reports.

9. The method for assessing risk in new business opportunities as claimed in claim 1, further comprising the step of calculating at least one of the following: present value, venture capital valuation, or another future value financial model.

10. A system for managing the development of a new business opportunity comprising:
a reporting system;
a portfolio risk management system;
at least one computing device in communication with the reporting system, and the portfolio risk management system, wherein the computing device is configured to:
a. create financial data and risk profile data for each new business opportunity;
b. utilize a hypothesis driven algorithm to create the optimal plan for de-risking each new business opportunity;
c. capture financial and risk components of each new business opportunity;
d. capture the financial and risk components of each new business opportunity in a portfolio management system; and
e. capture, record, and transparently link the market, technology, revenue, volume, cost, and timing hypothesis stated variables to underlying the new business opportunity and their level of validity to a business management system.

11. The system of managing the development of new business as claimed in claim 10, wherein the hypothesis driven algorithm includes at least one of the following hypothesis stated variables: market discontinuity as characterized by competitive methods, market opening, market need, identification of functional requirements, ability to technically satisfy functional requirements, price, volume, manufacturing cost, non-manufacturing cost, development cost and time to market.

12. The system of managing the development of new business as claimed in claim 10, further comprising:
a stage-gate system;
wherein the at least one computing device is further configured to integrate data into the stage-gate system by utilizing a business platform level of validity or certainty as staging criteria.

13. The system of managing the development of new business as claimed in claim 10, wherein the at least one computing device is further configured to calculate cash flow and net present value for the new business opportunity.

14. The system of managing the development of new business as claimed in claim 10, wherein the at least one computing device is operable to prioritize critical issues to be addressed so as to access risk of doing business with the new business opportunity.

15. The system of managing the development of new business as claimed in claim 10, wherein the at least one computing device is further configured to provide educational modules to teach users how to manage the development of new business.

16. A system for managing the risk of potential new business opportunities comprising:
at least one computing device configured to:
a. receive data in a computer hypothesis software program and save the data in a data base;
b. calculate cash flow and present value for a new business opportunity;
c. assign variances to a set of hypothesis stated variables;
d. prioritize the hypothesis stated variables from the lowest level of validity and the highest impact on value, and identify the most critical issues to be addressed in the new business;
e. aggregate each new business' commercial timing, business attractiveness, revenue at maturity, level of validity, relatedness by offering platform, and current resources at a business platform level;
f. generate a business platform map;
g. create actions, assignments, timing and milestones for the de-risking of the business platform and track the results;
h. aggregate project cash flows and offering platform cash flows at the business platform, a business portfolio, and an enterprise level to provide management reports;
i. analyze underlying hypotheses and their level of validity and impact on value behind the reports; and
j. sort each new business opportunity and prioritizing those that meet preferred criteria.

17. The system for managing the risk of potential new business opportunities as claimed in claim 16, wherein the computing device is configured to implement a web-based architecture which allows the computing device to communicate over a communication network.

18. The system for managing the risk of potential new business opportunities as claimed in claim 16, wherein the computing device is further configured to receive data from remote geographic locations.

19. The system for managing the risk of potential new business opportunities as claimed in claim 16, wherein the computing device is further configured to display, in real-time, management dashboards and financial reports.

20. The system for managing the risk of potential new business opportunities as claimed in claim 16, further comprising:
a remote server in communication with the computing device,
wherein the computing device is further configured to provide access to the database via the remote server.

21. A tangible computer readable medium embodying computer-executable instructions for automating hypothesis directed learning, the instructions comprising:
a. receiving, at a data entry screen, hypothesis of opportunity variables, their validity and financial impact considerations;
b. calculating, using a calculation algorithm, a financial characterization of costs, returns level of validity, uncertainty, variation and resource planning; and
c. outputting to a display output screen, data and calculated results to hierarchically identify risk, resources requirements and expected value.
